(19) United States
(12) Patent Application Publication
(10) Pub. No.: US 2023/0359292 A1
(43) Pub. Date: Nov. 9, 2023

(54) SCREEN CONTROL METHOD AND APPARATUS, AND ELECTRONIC DEVICE

(71) Applicant: VIVO MOBILE COMMUNICATION CO., LTD., Dongguan (CN)

(72) Inventors: Feng WANG, Dongguan (CN); Hong YIN, Dongguan (CN)

(73) Assignee: VIVO MOBILE COMMUNICATION CO., LTD., Dongguan (CN)

(21) Appl. No.: 18/222,477

(22) Filed: Jul. 16, 2023

Related U.S. Application Data
(63) Continuation of application No. PCT/CN2022/072133, filed on Jan. 14, 2022.

(30) Foreign Application Priority Data
Jan. 15, 2021 (CN) 202110057594.X

(51) Int. Cl. G06F 3/038; G06F 3/01; G06F 3/0346; G04G 21/02

(52) U.S. Cl. CPC G06F 3/038; G06F 3/014; G06F 3/0346; G04G 21/02

(57) ABSTRACT

This application discloses a screen control method and apparatus, and an electronic device. The method is performed by an electronic device, including: detecting a first motion parameter of the electronic device; determining a wearing position of the electronic device based on the first motion parameter; and turning on a screen of the electronic device when the wearing position is a first position and a second motion parameter of the electronic device meets a first preset condition, where the first preset condition corresponds to the first position; or turning off the screen of the electronic device when the wearing position is the first position and the second motion parameter of the electronic device meets a second preset condition, where the second preset condition corresponds to the first position.

### CROSS-REFERENCE TO RELATED APPLICATIONS

This application is a continuation of International Application No. PCT/CN2022/072133, filed Jan. 14, 2022, which claims priority to Chinese Patent Application No. 202110057594.X, filed Jan. 15, 2021. The entire contents of each of the above-referenced applications are expressly incorporated herein by reference.

### TECHNICAL FIELD

This application relates to the field of communications technologies, and specifically relates to a screen control method and apparatus, and an electronic device.

### BACKGROUND

With the technological development of electronic devices, there are more and more types of electronic devices. In an example in which an electronic device is a smartwatch, when a user uses the smartwatch, in order to save power, the existing smartwatch usually has a function of controlling a display screen to be on and off based on a motion state of a wrist of the user. Generally, the display screen of the smartwatch needs to be on when the wrist of the user is raised, and the display screen is off when the wrist of the user is lowered. This function can be implemented by determining a motion direction of the smartwatch by the smartwatch.

However, in the related art, there is a decision error of the electronic device in determining whether the display screen is turned on or turned off, thereby reducing efficiency in using the portable electronic device by the user.

### SUMMARY

Embodiments of this application aim to provide a screen control method and apparatus, and an electronic device.

According to a first aspect, an embodiment of this application provides a screen control method. The method is performed by an electronic device and includes: detecting, by the electronic device, a first motion parameter of the electronic device; determining, by the electronic device, a wearing position of the electronic device based on the first motion parameter; and turning on, by the electronic device, a screen of the electronic device in a case that the wearing position is a first position and a second motion parameter of the electronic device meets a first preset condition, where the first preset condition matches the first position; or turning off the screen of the electronic device in a case that the wearing position is the first position and the second motion parameter of the electronic device meets a second preset condition, where the second preset condition matches the first position.

According to a second aspect, an embodiment of this application provides a screen control apparatus, including: a detection module, a determining module, and a startup module. The detection module is configured to detect a first motion parameter of an electronic device; the determining module is configured to determine, based on the first motion parameter, a wearing position of a user wearing the electronic device; and the startup module is configured to: turn on a screen of the electronic device in a case that the determining module determines that the wearing position is a first position and a second motion parameter of the electronic device meets a first preset condition, where the first preset condition matches the first position; or turn off the screen of the electronic device in a case that the determining module determines that the wearing position is the first position and the second motion parameter of the electronic device meets a second preset condition, where the second preset condition matches the first position.

According to a third aspect, an embodiment of this application provides an electronic device. The electronic device includes a processor, a memory, and a program or an instruction that is stored in the memory and that can run on the processor, and when the program or the instruction is executed by the processor, the steps of the method according to the first aspect are implemented.

According to a fourth aspect, an embodiment of this application provides a readable storage medium. The readable storage medium stores a program or an instruction, and when the program or the instruction is executed by a processor, the steps of the method according to the first aspect are implemented.

According to a fifth aspect, an embodiment of this application provides a chip. The chip includes a processor and a communication interface, the communication interface is coupled to the processor, and the processor is configured to run a program or an instruction to implement the method according to the first aspect.

### BRIEF DESCRIPTION OF DRAWINGS

FIG. 1 is a flowchart of a screen control method according to an embodiment of this application;

FIGS. 2a-2b are first schematic diagrams of a variation fluctuation of a first motion parameter used in a screen control method according to an embodiment of this application;

FIGS. 3a-3b are second schematic diagrams of a variation fluctuation of a first motion parameter used in a screen control method according to an embodiment of this application;

FIG. 4 is a schematic structural diagram of a screen control apparatus according to an embodiment of this application;

FIG. 5 is a first schematic structural diagram of an electronic device according to an embodiment of this application; and

FIG. 6 is a second schematic structural diagram of an electronic device according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first”, “second”, and the like are intended to distinguish between similar objects but do not describe a specific order or sequence. It should be understood that, data used in such a way are interchangeable in proper circumstances, so that the embodiments of this application can be implemented in an order other than the order illustrated or described herein. Objects classified by “first”, “second”, and the like are usually of a same type, and the number of objects is not limited. For example, there may be one or more first objects. In addition, in the specification and the claims, “and/or” represents at least one of connected objects, and a character “/” generally represents an “or” relationship between associated objects.

The term “centripetal force parameter” in the embodiments of this application is explained as follows:

Centripetal force is resultant force directed toward a center of a circle (a center of curvature) as an object moves along a circumference or a curved track. The term “ centripetal force” is named from an effect produced by this resultant force action, and this effect may be produced by any force such as elastic force, gravity force, or friction force or may be provided by resultant force of several types of force or a component thereof.

Because a circular motion belongs to a curvilinear motion, the object in the circular motion is also subjected to resultant force having different velocity directions. The centripetal force is tension for the object in the circular motion, and a direction of the centripetal force constantly changes as the object moves on the curved track. This tension is directed toward a center of the circumference along a circumferential radius, and therefore is named as the “centripetal force”. The centripetal force is directed toward the center of the circumference, and the object controlled by the centripetal force moves in a tangential direction.

A magnitude of the centripetal force is closely related to a mass (m) of the object, a length (r) of the circumferential radius for movement of the object, and an angular velocity (ω).

The centripetal force parameter in the embodiments of this application may include a direction parameter of the centripetal force.

With reference to the accompanying drawings, a screen control method provided in the embodiments of this application is described in detail by using specific embodiments and application scenes.

The screen control method provided in the embodiments of this application may be used in a scene containing a detectable centripetal force parameter when a user wears an electronic device during motion.

For the scene containing the detectable centripetal force parameter when the user wears the electronic device during motion, functions and types of existing electronic devices are increasing. In an example in which the electronic device is a smartwatch, when the user wears the smartwatch, in order to save power, the existing smartwatch usually has a function of controlling a display screen to be on and off based on a motion state of a wrist of the user. Generally, the display screen of the smartwatch needs to be on when the wrist of the user is raised, and the display screen is off when the wrist of the user is lowered. This function can be implemented by determining a motion direction of the smartwatch by the smartwatch.

However, when the electronic device is at different positions, it is determined that motion directions of the display screen are different in on and off states. For example, when the smartwatch is worn on a left hand and a right hand, it is determined that the motion directions of the display screen are exactly opposite in the on and off states. Therefore, in a case that an accurate wearing position of the electronic device cannot be accurately determined, there is a decision error of the electronic device in determining whether the display screen is turned on or turned off, thereby reducing efficiency in using the electronic device by the user.

In this embodiment of this application, in a case that a user wears an electronic device, the electronic device first detects a first motion parameter of the electronic device, and then determines, based on the detected first motion parameter, a wearing position of a user wearing the electronic device. After the wearing position is determined, a screen of the electronic device is turned on in a case that the wearing position is a first position and a second motion parameter of the electronic device meets a first preset condition; or the screen of the electronic device is turned off in a case that the wearing position is the first position and the second motion parameter of the electronic device meets a second preset condition, where the first preset condition and the second preset condition respectively match the first position. In this way, the first motion parameter of the electronic device is detected, so that the wearing position of the user wearing the electronic device can be accurately determined. Therefore, a screen-on operation and a screen-off operation can be accurately determined when the user raises a wrist to view the electronic device, and the user can view content displayed on a display screen of the electronic device, thereby improving efficiency of using the electronic device by the user.

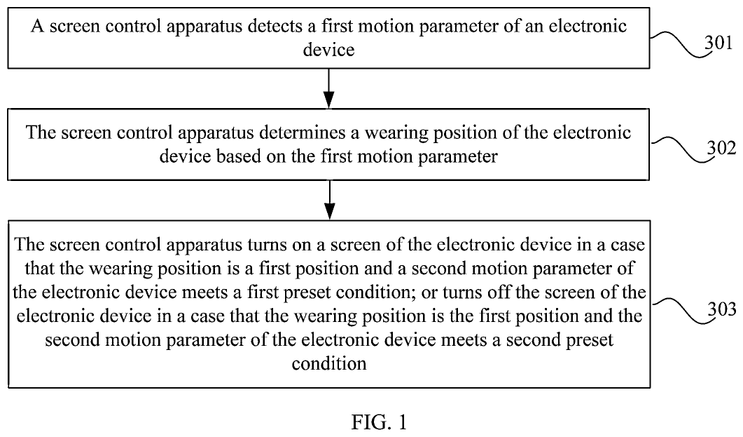

This embodiment provides a screen control method. As shown in FIG. 1, this embodiment is applied to an electronic device. The screen control method includes step 301 to step 303.

Step 301: A screen control apparatus detects a first motion parameter of the electronic device.

In this embodiment of this application, the electronic device may be a portable electronic device, and the portable electronic device may be a portable smartwatch or another wearable smart electronic device. This is not limited in this embodiment of this application.

In this embodiment of this application, the screen control apparatus may continuously detect the first motion parameter of the electronic device, or may periodically detect the first motion parameter of the electronic device.

In this embodiment of this application, the first motion parameter is a parameter for determining a wearing position of the electronic device in a parameter corresponding to a current motion state of the electronic device.

In an example, the first motion parameter may include a direction parameter, a velocity parameter, and the like. Generally, an acceleration parameter and a direction parameter of centripetal force may be included. This is not limited in this embodiment of this application.

In this embodiment of this application, the electronic device may detect the first motion parameter by using a motion state detection device inside the electronic device.

In an example, the electronic device may detect the first motion parameter by using a built-in gyroscope (gyro) and an acceleration sensor (acc). For example, a motion direction and a motion speed of the smartwatch are detected by using the built-in gyroscope.

It should be noted that in this embodiment of this application, the motion state of the electronic device may be a motion state on a stable plane, for example, an X-Y axis plane. It may be understood that the foregoing plane may be a relative planes such as a plane conforming to two axes (for example, a plane in any direction composed of two axes relative to 90°), and is not necessarily an absolute plane such as an absolute horizontal plane. In an example, the motion state on the stable plane may be a translational motion on any two-axis plane. For example, when the two-axis plane is an X-Y axis plane, the motion state may be a translational rotational motion of the electronic device on the X-Y axis plane.

Step 302: The screen control apparatus determines a wearing position of the electronic device based on the first motion parameter.

In this embodiment of this application, when the electronic device is worn at different positions, the electronic device corresponds to different first motion parameters. The electronic device may prestore a correspondence between a first motion parameters and a wearing position in the electronic device, or a user may customize the correspondence between a first motion parameters and a wearing position. This is not limited in this embodiment of this application.

It should be noted that when the electronic device is a device worn by the user, this embodiment of this application may be performed in a case that the electronic device does not set the wearing position or it is detected that the user removes the electronic device and the wearing position needs to be reset. After the wearing position is determined, if no change of the wearing position by the electronic device is detected, the determined result may be continuously used as the default wearing position, or steps 301 and 302 may be repeatedly performed by using the first motion parameter, and the first motion parameter is continuously detected and the accurate wearing position is determined. This is not limited in this embodiment of this application.

Step 303: The screen control apparatus turns on a screen of the electronic device in a case that the wearing position is a first position and a second motion parameter of the electronic device meets a first preset condition; or turns off the screen of the electronic device in a case that the wearing position is the first position and the second motion parameter of the electronic device meets a second preset condition.

In this embodiment of this application, the first preset condition matches the first position, and the second preset condition matches the first position.

In this embodiment of this application, the first position may be an example wearing position of the electronic device. For example, the user wears the electronic device on a left wrist and the left wrist is the first position.

In this embodiment of this application, the second motion parameter is a motion parameter for determining whether the electronic device is in a screen-on state or a screen-off state in a case that the wearing position of the electronic device is the first position. For example, assuming that the first position is the left wrist, the second motion parameter is a motion parameter of a motion process in which the user raises the wrist to the front, or a motion parameter of a motion process in which the user lowers the wrist.

In this embodiment of this application, the first preset condition is a condition corresponding to a case that the second motion parameter may meet a screen-on condition, and the second preset condition is a condition corresponding to a case that the second motion parameter may meet a screen-off condition.

In this embodiment of this application, the first preset condition and the second preset condition may be preset thresholds of different region ranges. The preset threshold may be preset by the electronic device, or may be defined by the user. This is not limited in this embodiment of this application.

It may be understood that the first preset condition and the second preset condition may be a same type of representation as the second motion parameter. For example, when the second motion parameter is an angle parameter, the first preset condition and the second preset condition may be respectively angle parameter ranges corresponding to a screen-on state and a screen-off state. In some embodiments, the first preset condition and the second preset condition may be different types of representation from the second motion parameter. For example, when the second motion parameter is an angle parameter, the first preset condition and the second preset condition are respectively direction parameters corresponding to a screen-on state and a screen-off state. When obtaining the angle parameter, the electronic device may convert the angle parameter into a direction parameter, and compare the direction parameter with the first preset condition and the second preset condition, thereby determining a screen-on state and a screen-off state.

In an example, the second motion parameter may be a Z-axis rotation direction parameter when the electronic device moves. Generally, the electronic device may determine the Z-axis rotation direction parameter by using a gyroscope. The first preset condition may be a parameter range of a Z-axis rotation direction parameter corresponding to a screen-on state when the electronic device is worn at different positions, and the second preset condition may be a parameter range of a Z-axis rotation direction parameter corresponding to a screen-off state when the electronic device is worn at different positions.

For example, when the electronic device is a smartwatch, and it is determined that the smartwatch is worn on the left wrist of the user (that is, the first position), if the gyroscope of the electronic device learns that the electronic device rotates clockwise along a Z-axis rotation direction (that is, the first preset condition), the screen is turned on, and if the gyroscope of the electronic device learns that the electronic device rotates counterclockwise along the Z-axis rotation direction (that is, the second preset condition), the screen is turned off.

According to the screen control method provided in this embodiment of this application, a screen control apparatus first detects a first motion parameter of the electronic device, and then determines, based on the detected first motion parameter, a wearing position of a user wearing the electronic device. After the wearing position is determined, a screen of the electronic device is turned on in a case that the wearing position is a first position and a second motion parameter of the electronic device meets a first preset condition; or the screen of the electronic device is turned off in a case that the wearing position is the first position and the second motion parameter of the electronic device meets a second preset condition, where the first preset condition and the second preset condition respectively match the first position. In this way, the first motion parameter of the electronic device is detected, so that the wearing position of the user wearing the electronic device can be accurately determined. Therefore, a screen-on operation and a screen-off operation can be accurately determined when the user raises a wrist to view the electronic device, and the user can view content displayed on a display screen of the electronic device, thereby improving efficiency of using the electronic device by the user.

In some embodiments of this application, in step 302 of determining a wearing position of the electronic device based on the first motion parameter, the screen control method provided in this embodiment of this application may include the following step A:

Step A: In a case that the first motion parameter includes a centripetal force parameter of the electronic device moving along a curved track, the screen control apparatus determines, based on the first motion parameter, a wearing position of a user wearing the electronic device.

In this embodiment of this application, the curved track is a motion track when the electronic device moves.

In an example, in a case that the electronic device is worn at a wrist, the motion track may include a circular motion with an elbow joint as a center, and the curved track may be a curved track of the circular motion with the elbow joint as the center.

In this embodiment of this application, for the centripetal force parameter, refer to the foregoing descriptions. Details are not described herein again.

In this embodiment of this application, when the centripetal force parameter includes a centripetal force direction and a centripetal acceleration, different centripetal force directions and centripetal accelerations may indicate centripetal force parameters of different motions of the electronic device, and correspond to different wearing positions.

In an example, when the wearing position of the electronic device is a wrist, a circular motion in which the electronic device is worn on a left wrist corresponds to a circular motion in which the electronic device is worn on a right wrist. Generally, in a process of the circular motion of the left wrist or the right wrist, static friction force is generated between the electronic device and the wrist, and a centripetal force parameter corresponding to the static friction force is generated. Since a motion direction of the circular motion on the left wrist is opposite to that on the right wrist, the accurate wearing position of the electronic device may be determined based on a change of centripetal force directions and centripetal accelerations of different centripetal force parameters corresponding to different circular motions.

In some embodiments of this application, in step 302 of determining, based on the first motion parameter, a wearing position of a user wearing the electronic device, the screen control method provided in this embodiment of this application may include the following step B1 and step B2:

Step B1: In a case that the first motion parameter meets a third preset condition, the screen control apparatus determines that the electronic device is worn on a left hand of the user.

Step B2: In a case that the first motion parameter meets a fourth preset condition, the screen control apparatus determines that the electronic device is worn on a right hand of the user.

In some embodiments of this application, the centripetal force parameter further includes a first centripetal force parameter in a first direction and a second centripetal force parameter in a second direction.

For example, the first direction and the second direction are two directions perpendicular to each other on a plane in which a display screen of the electronic device is located.

For example, the third preset condition is that the first centripetal force parameter changes from a negative value to a positive value, and the centripetal force parameter in the second direction changes from a positive value to a negative value; and the fourth preset condition is that the first centripetal force parameter changes from a positive value to a negative value, and the second centripetal force parameter changes from a negative value to a positive value.

For example, the third preset condition and the fourth preset condition may be prestored in the electronic device by the electronic device, or may be customized by the user. This is not limited in this embodiment of this application.

For example, the third preset condition may be a correspondence between a first motion parameter and a wearing position when the electronic device is worn on the left hand. Similarly, the fourth preset condition may be a correspondence between a first motion parameter and a wearing position when the electronic device is worn on the right hand.

For example, the first direction and the second direction may be two axes of the two-axis plane, and directions of the two axes may be respectively the first direction and the second direction.

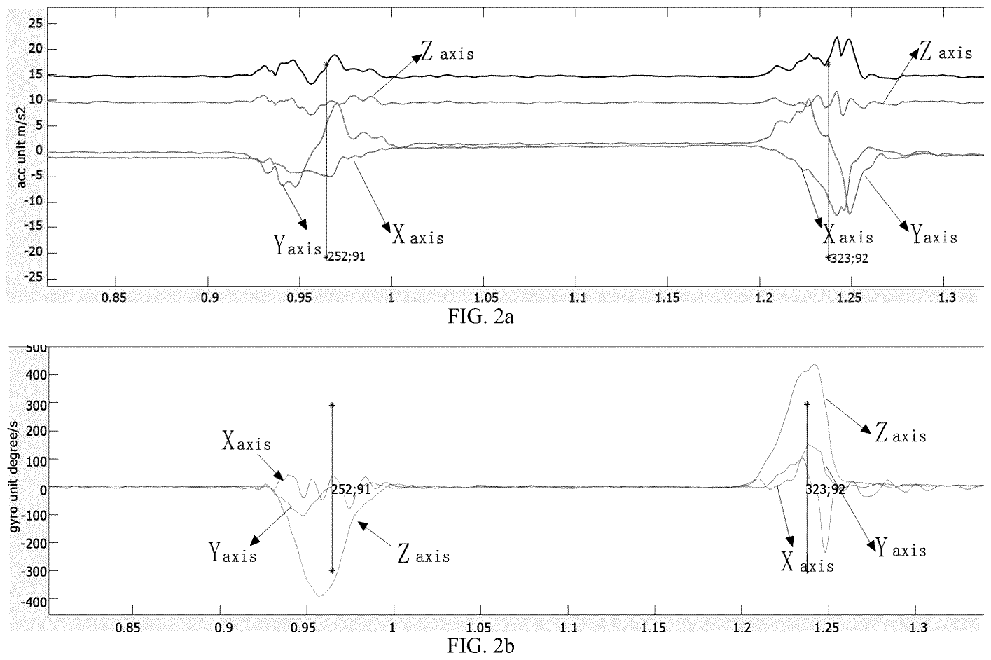

Example 1: Assuming that the electronic device is a smartwatch, and the first motion parameter is an acceleration and a centripetal force parameter, in a case that the user wears the smartwatch on the left wrist and the left hand is placed at rest on a desktop to continuously operate a computer mouse, the smartwatch automatically continuously detects a first motion parameter of the smartwatch. As shown in FIG. 2a and FIG. 2b, FIG. 2a is a fluctuation diagram of a change in a centripetal acceleration, and FIG. 2b is a fluctuation diagram of a change in a centripetal angular velocity. As shown in the figure, before a time point 9.5 s, an acc sensor and a gyro of the smartwatch detect that a centripetal acceleration and a centripetal angular velocity of the smartwatch in X, Y, and Z axes fluctuate around 0 until a time period before and after 9.5 s. In this time period, if a right arm of the user rotates counterclockwise with an elbow joint as an axis along a curved track of the circumference through a circular motion to move the wrist to the front, the acc detects that a centripetal acceleration in the Z axis fluctuates and a centripetal acceleration in the X axis is a negative value, and correspondingly, at the wrist, the smartwatch is directed toward a humerus from the wrist, and a centripetal acceleration in the Y axis changes from a negative value to a positive value, that is, the smartwatch is first subjected to thrust and then to tension, and the gyro detects that a centripetal angular velocity in the Z axis suddenly changes to −400 degrees/second and then rapidly changes to 0 degrees/second, and the centripetal angular velocity is a negative value. It may be learned from this centripetal angular velocity that the smartwatch rotates clockwise.

In a time period before and after 12.5 s, if a left arm of the user rotates the wrist clockwise to the mouse with an elbow joint as an axis along a curved track of the circumference through a circular motion, the acc detects that a centripetal acceleration in the Z axis fluctuates, a centripetal acceleration in the X axis is a negative value, and a centripetal acceleration in the Y axis changes from a positive value to a negative value, that is, the smartwatch is subjected to tension and then to thrust, and the gyro detects that a centripetal angular velocity in the Z axis suddenly changes to 400 degrees/second and then rapidly increases to 0 degrees/second, and the centripetal angular velocity is a positive value. It may be comprehensively determined, based on the centripetal acceleration and the angular velocity, that the smartwatch rotates counterclockwise.

Through the above two changes of the first motion parameter, based on the preset correspondence between a first motion parameter and a wearing position (that is, the first motion parameter meets the first preset condition), it may be determined that the smartwatch is worn on the left hand.

After it is determined that the smartwatch is worn on the left hand, when the gyro detects that a rotation direction of the electronic device along the Z axis (that is, the second motion parameter) is clockwise rotation (that is, the first preset condition), the screen is turned on, or if the gyro of the smartwatch detects that the rotation direction of the smartwatch along the Z axis (that is, the second motion parameter) is counterclockwise rotation (that is, the second preset condition), the screen is turned off.

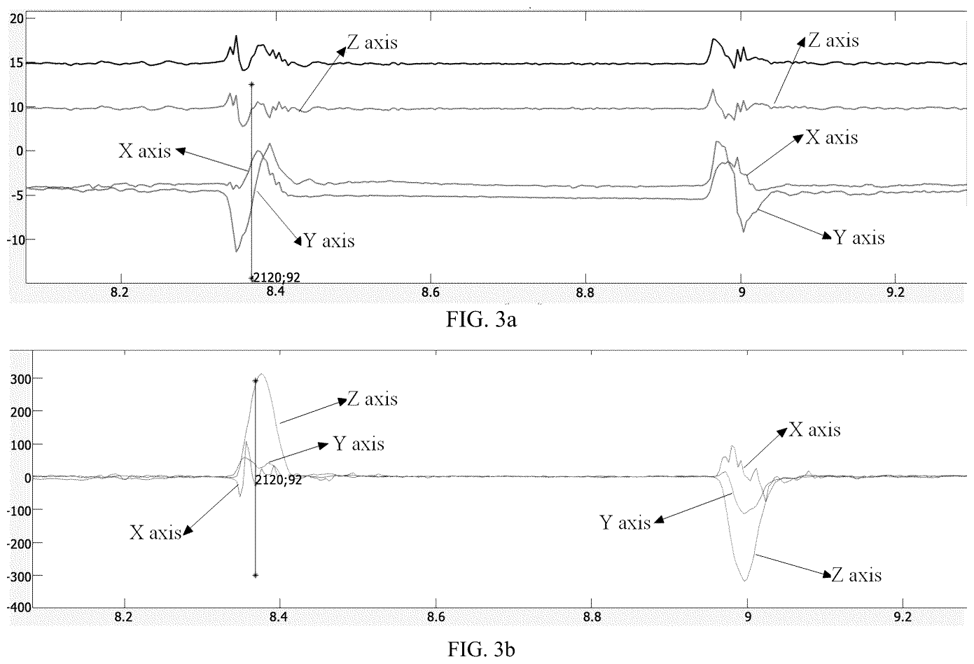

Example 2: Assuming that the electronic device is a smartwatch, and the first motion parameter is an acceleration and a centripetal force parameter, in a case that the user wears the smartwatch on the right wrist and the right hand is placed at rest on a desktop to continuously operate a computer mouse, the smartwatch automatically continuously detects a first motion parameter of the smartwatch. As shown in FIG. 3a and FIG. 3b, FIG. 3a is a fluctuation diagram of a change in a centripetal acceleration, and FIG. 3b is a fluctuation diagram of a change in a centripetal angular velocity. Before a time point 84 s, an acc sensor and a gyro of the smartwatch detect that a centripetal acceleration and a centripetal angular velocity of the smartwatch in X, Y, and Z axes fluctuate around 0 until a time period before and after 84 s. In this time period, if a right arm of the user rotates counterclockwise with an elbow joint as an axis along a curved track of the circumference through a circular motion to move the wrist to the front, the acc detects that a centripetal acceleration in the Z axis fluctuates and a centripetal acceleration in the X axis is a positive value, and correspondingly, at the wrist, the smartwatch is directed toward a humerus from the wrist, and an acceleration in the Y axis changes from a negative value to a positive value, that is, the smartwatch is first subjected to thrust and then to tension, and the gyro detects that a centripetal angular velocity in the Z axis suddenly changes to 300 degrees/second and then rapidly reduces to 0 degrees/second, and the centripetal angular velocity is a positive value. It may be learned from this centripetal angular velocity that the smartwatch rotates counterclockwise.

In a time period before and after 90 s, if a right arm of the user rotates the wrist clockwise to the mouse with an elbow joint as an axis along a curved track of the circumference through a circular motion, the acc detects that a centripetal acceleration in the Z axis fluctuates, a centripetal acceleration in the X axis is a positive value, and a centripetal acceleration in the Y axis changes from a positive value to a negative value, that is, the smartwatch is subjected to thrust and then to tension, and the gyro detects that a centripetal angular velocity in the Z axis suddenly increases to −300 degrees/second and then rapidly increases to 0 degrees/second, and the centripetal angular velocity is a negative value. It may be comprehensively determined, based on the centripetal acceleration and the angular velocity, that the smartwatch rotates clockwise.

Through the above two changes of the first motion parameter, based on the preset correspondence between a first motion parameter and a wearing position (that is, the first motion parameter meets the second preset condition), it may be determined that the smartwatch is worn on the right hand.

After it is determined that the smartwatch is worn on the right hand, when the gyro detects that a rotation direction of the electronic device along the Z axis is counterclockwise rotation (that is, the first preset condition), the screen is turned on, or if the gyro of the smartwatch detects that the rotation direction of the smartwatch along the Z axis is clockwise rotation (that is, the second preset condition), the screen is turned off.

It may be understood that in the foregoing example 1 and example 2, because the two hand operations of the user are stationary, the thrust and the tension are approximately equal to each other in opposite directions. For example, an integral area of the acceleration sensor acc in a positive direction in the Y axis is equal to an integral area in a negative direction. However, there is no positive-negative cancellation of the acceleration sensor in the X axis. Therefore, there is no combination of the thrust and the tension, and only static friction is used as centripetal force. In an example, sliding friction may be used as centripetal force in a case that there is a relative motion between a dial of the smartwatch and the hand.

In this way, the electronic device may accurately determine based on a preset condition and the obtained first motion parameter, that the electronic device is worn on the left hand or the right hand, and further, the electronic device may accurately determine a moment at which the user needs to view and turn on or turn off the screen, thereby reducing resource consumption of the electronic device.

In some embodiments of this application, after step 302 of determining a wearing position of the electronic device based on the first motion parameter, the screen control method provided in this embodiment of this application further includes the following step C:

Step C: The screen control apparatus redetermines the wearing position of the electronic device in a case that an obstacle is detected in a predetermined region at a position at which the electronic device is located.

For example, the electronic device may detect a shielding object by using a sensor. For example, the electronic device may detect the shielding object by using an infrared sensor, or may detect the shielding object by using a capacitive touch sensor.

For example, the predetermined region may be preset by the electronic device or may be customized by the user.

For example, the screen control apparatus may redetermine the wearing position of the electronic device by redetecting the first motion parameter of the electronic device.

For example, the predetermined region may be determined based on a condition of redetecting the first motion parameter of the electronic device.

In an example, when the condition for redetecting the first motion parameter of the electronic device is that the user removes the electronic device, the predetermined region may be set on the back of the electronic device, and in a case that the electronic device is disconnected from the user, the electronic device may sense, through the sensor, that the back of the electronic device changes from being shielded to unshielded, and further perform step 301 and step 302, redetect the first motion parameter of the electronic device, and further redetermine the wearing position of the electronic device.

In this way, the electronic device may redetect the first motion parameter of the electronic device in a specific case, and then redetermine the wearing position. Therefore, in a case that the wearing position is accurately determined, the first motion parameter does not need to be continuously detected, so that resource consumption of the electronic device can be reduced.

In some embodiments of this application, in step 301, the screen control method provided in this embodiment of this application may include the following step D:

Step D: The screen control apparatus detects the first motion parameter of the electronic device in a case that the electronic device is in a preset motion state in a third direction.

For example, the third direction is a direction perpendicular to the plane in which the display screen of the electronic device is located.

For example, the preset motion state may be that the first motion parameter in the third direction exceeds a preset threshold.

It may be understood that when the electronic device is in a stable state on the two-axis plane (that is, in a case that there is no centripetal force parameter exceeding the preset threshold, for example, an arm is placed at rest on the two-axis plane), the electronic device does not have the centripetal force parameter. In a case that the first motion parameter of the electronic device in the third direction reaches the preset threshold, the electronic device may determine that the electronic device has the centripetal force parameter, and may determine the wearing position of the portable electronic device by detecting the first motion parameter.

In an example, the first motion parameter in the third direction may be a first motion parameter for a circular motion around the third direction in a plane in which the first direction and the second direction lie. The first motion parameter may include centripetal force parameters in the first direction, the second direction, and the third direction, and the centripetal force parameter may include a centripetal angular velocity and a centripetal acceleration.

Example 3: For example, the electronic device is a smartwatch, the first direction is an X axis, the second direction is a Y axis, and the third direction is a Z axis. In a case that the smartwatch is stationary on an X-Y plane and circumferentially moves around the Z axis, a motion amplitude is less than a preset threshold. Therefore, the first motion parameter is not detected until the smartwatch circumferentially moves around the Z axis, so that a motion amplitude in the Z axis is greater than or equal to the preset threshold, and the first motion parameter of the electronic device is detected.

In this way, a timing for detecting the first motion parameter of the electronic device may be determined based on the preset motion state in the third direction, so that screen control is detected at an appropriate timing, and the wearing position of the portable electronic device can be accurately determined.

It should be noted that the screen control method provided in the embodiments of this application may be performed by a screen control apparatus, or a control module that is in the screen control apparatus and that is configured to perform the screen control method. In the embodiments of this application, that the screen control apparatus performs the screen control method is used as an example to describe the screen control apparatus provided in the embodiments of this application.

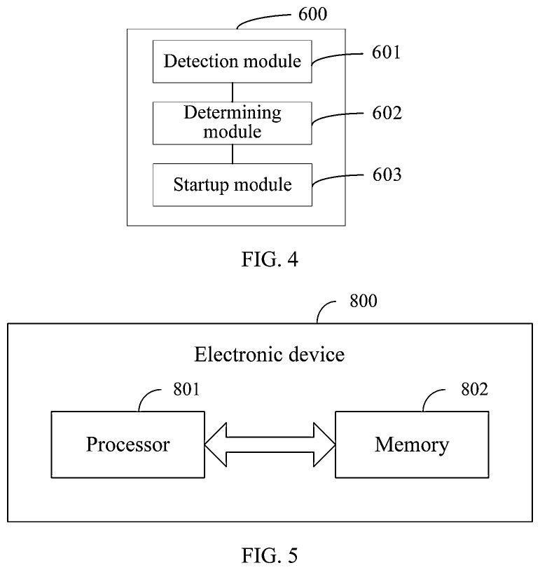

FIG. 4 is a possible schematic structural diagram of a screen control apparatus according to an embodiment of this application. As shown in FIG. 4, the screen control apparatus 600 includes a detection module 601, a determining module 602, and a startup module 603. The detection module 601 is configured to detect a first motion parameter of an electronic device; the determining module is configured to determine, based on the first motion parameter detected by the detection module 600, a wearing position of a user wearing the electronic device; and the startup module 603 is configured to: turn on a screen of the electronic device in a case that the determining module 602 determines that the wearing position is a first position and a second motion parameter of the electronic device meets a first preset condition, where the first preset condition matches the first position; or turn off the screen of the electronic device in a case that the determining module determines that the wearing position is the first position and the second motion parameter of the electronic device meets a second preset condition, where the second preset condition matches the first position.

According to the screen control apparatus provided in this embodiment of this application, the screen control apparatus first detects a first motion parameter of the electronic device, and then determines, based on the detected first motion parameter, a wearing position of a user wearing the electronic device. After the wearing position is determined, a screen of the electronic device is turned on in a case that the wearing position is a first position and a second motion parameter of the electronic device meets a first preset condition; or the screen of the electronic device is turned off in a case that the wearing position is the first position and the second motion parameter of the electronic device meets a second preset condition, where the first preset condition and the second preset condition respectively match the first position. In this way, the first motion parameter of the electronic device is detected, so that the wearing position of the user wearing the electronic device can be accurately determined. Therefore, a screen-on operation and a screen-off operation can be accurately determined when the user raises a wrist to view the electronic device, and the user can view content displayed on a display screen of the electronic device, thereby improving efficiency of using the electronic device by the user.

In some embodiments of this application, the determining module 602 is configured to: in a case that the detection module 601 detects that the first motion parameter includes a centripetal force parameter of the electronic device moving along a curved track, determine the wearing position of the electronic device based on the first motion parameter.

In some embodiments of this application, the determining module 602 is configured to: in a case that the first motion parameter meets a third preset condition, determine that the electronic device is worn on a left hand of the user; or the determining module 602 is configured to: in a case that the first motion parameter meets a fourth preset condition, determine that the electronic device is worn on a right hand of the user.

In some embodiments of this application, the centripetal force parameter includes a first centripetal force parameter in a first direction and a second centripetal force parameter in a second direction. The first direction and the second direction are two directions perpendicular to each other on a plane in which a display screen of the electronic device is located. The third preset condition is that the first centripetal force parameter changes from a negative value to a positive value, and the centripetal force parameter in the second direction changes from a positive value to a negative value; and the fourth preset condition is that the first centripetal force parameter changes from a positive value to a negative value, and the second centripetal force parameter changes from a negative value to a positive value.

In some embodiments of this application, the detection module is further configured to redetermine the wearing position of the electronic device in a case that an obstacle is detected in a predetermined region at a position at which the electronic device is located.

In some embodiments of this application, the detection module 601 is configured to detect the first motion parameter of the electronic device in a case that the electronic device is in a preset motion state in a third direction, where the third direction is a direction perpendicular to the plane in which the display screen of the electronic device is located.

The screen control apparatus in this embodiment of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a laptop computer, a palmtop computer, an in-vehicle electronic device, a wearable device, an ultra-mobile personal computer (UMPC), a netbook, or a personal digital assistant (PDA). The non-mobile electronic device may be a server, a network attached storage (NAS), a personal computer (PC), a television (TV), an automated teller machine, or a self-service machine. This is not specifically limited in the embodiments of this application.

The screen control apparatus in this embodiment of this application may be an apparatus with an operating system. The operating system may be an Android operating system, an iOS operating system, or another possible operating system. This is not specifically limited in this embodiment of this application.

The screen control apparatus provided in this embodiment of this application can implement the processes implemented in the method embodiments in FIG. 1 to FIGS. 3a-3b. To avoid repetition, details are not described herein again.

It should be noted that, as shown in FIG. 4, modules such as the detection module 601 necessarily included in the screen control apparatus 600 is illustrated by a solid-line box.

As shown in FIG. 5, embodiments of this application further provide an electronic device 800, including a processor 801, a memory 802, and a program or an instruction that is stored in the memory 802 and that can run on the processor 801. When the program or the instruction is executed by the processor 801, the processes of the screen control method embodiment are implemented, and a same technical effect can be achieved. To avoid repetition, details are not described herein again.

It should be noted that the electronic device in this embodiment of this application includes the foregoing mobile electronic device and the foregoing non-mobile electronic device.

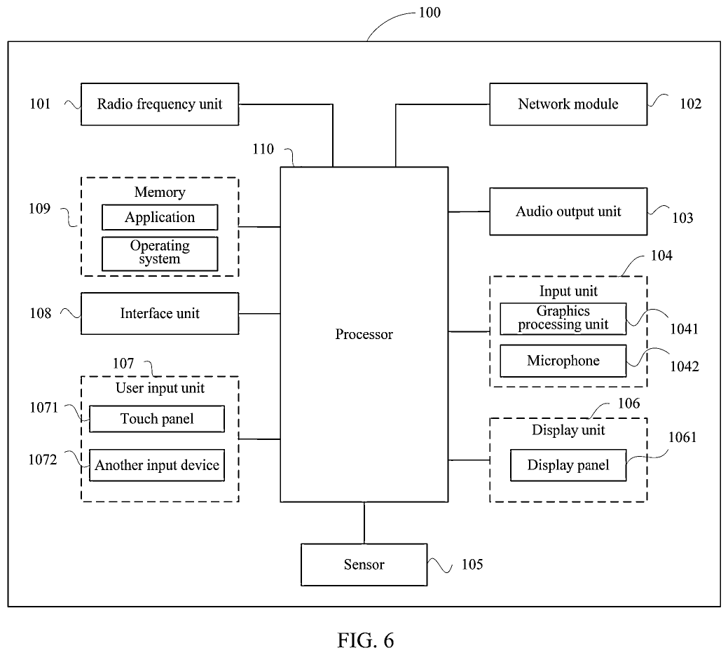

FIG. 6 is a schematic diagram of a hardware structure of an electronic device according to an embodiment of this application.

The electronic device 100 includes but is not limited to components such as a radio frequency unit 101, a network module 102, an audio output unit 103, an input unit 104, a sensor 105, a display unit 106, a user input unit 107, an interface unit 108, a memory 109, and a processor 110. The user input unit 107 includes a touch panel 1071 and another input device 1072. The display unit 106 includes a display panel 1061, the input unit 104 includes an image processor 1041 and a microphone 1042, and the memory 109 may be configured to store a software program (for example, an operating system and an application required by at least one function) and various types of data.

A person skilled in the art can understand that the electronic device 100 may further include a power supply (such as a battery) that supplies power to each component. The power supply may be logically connected to the processor 110 by using a power supply management system, to implement functions such as charging and discharging management, and power consumption management by using the power supply management system. The structure of the electronic device shown in FIG. 6 does not constitute a limitation on the electronic device. The electronic device may include components more or fewer than those shown in the diagram, a combination of some components, or different component arrangements. Details are not described herein.

The processor 110 is configured to detect a first motion parameter of an electronic device; the processor 110 is further configured to determine, based on the first motion parameter, a wearing position of a user wearing the electronic device; and the processor 110 is further configured to: turn on a screen of the electronic device in a case that the wearing position is a first position and a second motion parameter of the electronic device meets a first preset condition, where the first preset condition matches the first position; or turn off the screen of the electronic device in a case that the wearing position is the first position and the second motion parameter of the electronic device meets a second preset condition, where the second preset condition matches the first position.

According to the electronic device provided in this embodiment of this application, the electronic device first detects a first motion parameter of the electronic device, and then determines, based on the detected first motion parameter, a wearing position of a user wearing the electronic device. After the wearing position is determined, a screen of the electronic device is turned on in a case that the wearing position is a first position and a second motion parameter of the electronic device meets a first preset condition; or the screen of the electronic device is turned off in a case that the wearing position is the first position and the second motion parameter of the electronic device meets a second preset condition, where the first preset condition and the second preset condition respectively match the first position. In this way, the first motion parameter of the electronic device is detected, so that the wearing position of the user wearing the electronic device can be accurately determined. Therefore, a screen-on operation and a screen-off operation can be accurately determined when the user raises a wrist to view the electronic device, and the user can view content displayed on a display screen of the electronic device, thereby improving efficiency of using the electronic device by the user.

In some embodiments, the processor 110 is configured to: in a case that the first motion parameter includes a centripetal force parameter of the electronic device moving circumferentially along a curved track, determine the wearing position of the electronic device based on the first motion parameter.

The processor 110 is configured to: in a case that the first motion parameter meets a third preset condition, determine that the electronic device is worn on a left hand of the user; or the processor 110 is configured to: in a case that the first motion parameter meets a fourth preset condition, determine that the electronic device is worn on a right hand of the user.

In some embodiments, the processor 110 is further configured to redetermine the wearing position of the electronic device in a case that an obstacle is detected in a predetermined region at a position at which the electronic device is located.

In some embodiments, the processor 110 is configured to detect the first motion parameter of the electronic device in a case that the electronic device is in a preset motion state in a third direction, where the third direction is a direction perpendicular to the plane in which the display screen of the electronic device is located.

It should be understood that, in this embodiment of this application, the input unit 104 may include a graphics processing unit (GPU) 1041 and a microphone 1042, and the graphics processing unit 1041 processes image data of a still picture or a video obtained by an image capture apparatus (such as a camera) in a video capture mode or an image capture mode. The display unit 106 may include a display panel 1061. In some embodiments, the display panel 1061 may be configured in a form such as a liquid crystal display or an organic light-emitting diode. The user input unit 107 includes a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein. The memory 109 may be configured to store a software program and various data, including but not limited to an application and an operating system. An application processor and a modem processor may be integrated into the processor 110, the application processor mainly processes an operating system, a user interface, an application program, and the like, and the modem processor mainly processes wireless communication. It can be understood that, the modem processor may not be integrated into the processor 110.

An embodiment of this application further provides a readable storage medium. The readable storage medium stores a program or an instruction, and when the program or the instruction is executed by a processor, the processes of the foregoing screen control method embodiment are implemented and a same technical effect can be achieved. To avoid repetition, details are not described herein again.

The processor is a processor in the electronic device in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communications interface, the communications interface is coupled to the processor, and the processor is configured to run a program or an instruction to implement the processes of the foregoing screen control method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A screen control method, performed by an electronic device, comprising:
detecting a first motion parameter of the electronic device;
determining a wearing position of the electronic device based on the first motion parameter; and
turning on a screen of the electronic device when the wearing position is a first position and a second motion parameter of the electronic device meets a first preset condition, wherein the first preset condition corresponds to the first position; or turning off the screen of the electronic device when the wearing position is the first position and the second motion parameter of the electronic device meets a second preset condition, wherein the second preset condition corresponds to the first position.

2. The screen control method according to claim 1, wherein determining the wearing position of the electronic device based on the first motion parameter comprises:
when the first motion parameter comprises a centripetal force parameter of the electronic device moving along a curved track, determining the wearing position of the electronic device based on the first motion parameter.

3. The screen control method according to claim 2, wherein determining the wearing position of the electronic device based on the first motion parameter comprises:
when the first motion parameter meets a third preset condition, determining that the electronic device is worn on a left hand of a user; or
when the first motion parameter meets a fourth preset condition, determining that the electronic device is worn on the right hand of the user.

4. The screen control method according to claim 3, wherein the centripetal force parameter comprises a first centripetal force parameter in a first direction and a second centripetal force parameter in a second direction,
wherein the first direction and the second direction are two directions perpendicular to each other on a plane in which a display screen of the electronic device is located;
the third preset condition is that the first centripetal force parameter changes from a negative value to a positive value, and the centripetal force parameter in the second direction changes from a positive value to a negative value; and
the fourth preset condition is that the first centripetal force parameter changes from a positive value to a negative value, and the second centripetal force parameter changes from a negative value to a positive value.

5. The screen control method according to claim 1, wherein after determining the wearing position of the electronic device based on the first motion parameter, the method further comprises:
redetermining the wearing position of the electronic device when an obstacle is detected in a predetermined region at a position at which the electronic device is located.

6. The screen control method according to claim 1, wherein detecting the first motion parameter of the electronic device comprises:
detecting the first motion parameter of the electronic device when the electronic device is in a preset motion state in a third direction,
wherein the third direction is a direction perpendicular to the plane in which the display screen of the electronic device is located.

7. An electronic device, comprising:
a memory storing a computer program; and
a processor coupled to the memory and configured to execute the computer program to perform operations comprising:
detecting a first motion parameter of the electronic device;
determining a wearing position of the electronic device based on the first motion parameter; and
turning on a screen of the electronic device when the wearing position is a first position and a second motion parameter of the electronic device meets a first preset condition, wherein the first preset condition corresponds to the first position; or turning off the screen of the electronic device when the wearing position is the first position and the second motion parameter of the electronic device meets a second preset condition, wherein the second preset condition corresponds to the first position.

8. The electronic device according to claim 7, wherein determining the wearing position of the electronic device based on the first motion parameter comprises:
when the first motion parameter comprises a centripetal force parameter of the electronic device moving along a curved track, determining the wearing position of the electronic device based on the first motion parameter.

9. The electronic device according to claim 8, wherein determining the wearing position of the electronic device based on the first motion parameter comprises:
when the first motion parameter meets a third preset condition, determining that the electronic device is worn on a left hand of a user; or
when the first motion parameter meets a fourth preset condition, determining that the electronic device is worn on the right hand of the user.

10. The electronic device according to claim 9, wherein the centripetal force parameter comprises a first centripetal force parameter in a first direction and a second centripetal force parameter in a second direction,
wherein the first direction and the second direction are two directions perpendicular to each other on a plane in which a display screen of the electronic device is located;
the third preset condition is that the first centripetal force parameter changes from a negative value to a positive value, and the centripetal force parameter in the second direction changes from a positive value to a negative value; and
the fourth preset condition is that the first centripetal force parameter changes from a positive value to a negative value, and the second centripetal force parameter changes from a negative value to a positive value.

11. The electronic device according to claim 7, wherein after determining the wearing position of the electronic device based on the first motion parameter, the operations further comprise:
redetermining the wearing position of the electronic device when an obstacle is detected in a predetermined region at a position at which the electronic device is located.

12. The electronic device according to claim 7, wherein detecting the first motion parameter of the electronic device comprises:
detecting the first motion parameter of the electronic device when the electronic device is in a preset motion state in a third direction,
wherein the third direction is a direction perpendicular to the plane in which the display screen of the electronic device is located.

13. A non-transitory computer-readable storage medium, storing a computer program, when the computer program is executed by a processor, causes the processor to perform operations comprising:
detecting a first motion parameter of the electronic device;
determining a wearing position of the electronic device based on the first motion parameter; and
turning on a screen of the electronic device when the wearing position is a first position and a second motion parameter of the electronic device meets a first preset condition, wherein the first preset condition corresponds to the first position; or turning off the screen of the electronic device when the wearing position is the first position and the second motion parameter of the electronic device meets a second preset condition, wherein the second preset condition corresponds to the first position.

14. The non-transitory computer-readable storage medium according to claim 13, wherein determining the wearing position of the electronic device based on the first motion parameter comprises:
when the first motion parameter comprises a centripetal force parameter of the electronic device moving along a curved track, determining the wearing position of the electronic device based on the first motion parameter.

15. The non-transitory computer-readable storage medium according to claim 14, wherein determining the wearing position of the electronic device based on the first motion parameter comprises:
when the first motion parameter meets a third preset condition, determining that the electronic device is worn on a left hand of a user; or
when the first motion parameter meets a fourth preset condition, determining that the electronic device is worn on the right hand of the user.

16. The non-transitory computer-readable storage medium according to claim 15, wherein the centripetal force parameter comprises a first centripetal force parameter in a first direction and a second centripetal force parameter in a second direction,
wherein the first direction and the second direction are two directions perpendicular to each other on a plane in which a display screen of the electronic device is located;
the third preset condition is that the first centripetal force parameter changes from a negative value to a positive value, and the centripetal force parameter in the second direction changes from a positive value to a negative value; and
the fourth preset condition is that the first centripetal force parameter changes from a positive value to a negative value, and the second centripetal force parameter changes from a negative value to a positive value.

17. The non-transitory computer-readable storage medium according to claim 13, wherein after determining the wearing position of the electronic device based on the first motion parameter, the operations further comprise:
redetermining the wearing position of the electronic device when an obstacle is detected in a predetermined region at a position at which the electronic device is located.

18. The non-transitory computer-readable storage medium according to claim 13, wherein detecting the first motion parameter of the electronic device comprises:
detecting the first motion parameter of the electronic device when the electronic device is in a preset motion state in a third direction,
wherein the third direction is a direction perpendicular to the plane in which the display screen of the electronic device is located.
